(19) United States
(12) Patent Application Publication
(10) Pub. No.: US 2024/0266655 A1
(43) Pub. Date: Aug. 8, 2024

(54) BATTERY CELL AND BATTERY PACK INCLUDING THE SAME

(71) Applicant: SK On Co., Ltd., Seoul (KR)

(72) Inventors: Sung Yeon KIM, Daejeon (KR); Se Young PARK, Daejeon (KR); Seul Gi LEE, Daejeon (KR)

(21) Appl. No.: 18/404,889

(22) Filed: Jan. 5, 2024

(30) Foreign Application Priority Data
Feb. 7, 2023 (KR) 10-2023-0016073

(51) Int. Cl. H01M 50/242; H01M 50/209; H01M 50/211

(52) U.S. Cl. CPC H01M 50/242; H01M 50/209; H01M 50/211; H01M 2220/20

(57) ABSTRACT

The present disclosure relates to a battery pack comprising: one or more battery cells comprising a main body portion for accommodating an electrode assembly therein and a mounting portion provided outside of the main body portion; a pack tray comprising a lower panel formed in parallel with a stacking direction in which the one or more battery cells are stacked and both side panels extending upward from opposite edge positions of the lower panel, and accommodating the one or more battery cells; and a support bar of which both ends are connected to the both side panels and which is formed in parallel with the stacking direction, wherein the mounting portion is mounted on the support bar.

### CROSS-REFERENCE TO RELATED PATENT APPLICATION

The present application claims priority under 35 U.S.C. § 119(a) to Korean patent application number 10-2023-0016073 filed on Feb. 7, 2023, in the Korean Intellectual Property Office, the entire disclosure of which is incorporated by reference herein.

### BACKGROUND OF THE INVENTION

### 1. Field

The present disclosure relates to a battery cell and a battery pack including the same. Specifically, it relates to a battery cell and a battery pack capable of mounting a battery cell.

### 2. Description of the Related Art

As the electronics, communications, and space industries develop, demand for secondary batteries as an energy power source is drastically increasing. As the importance of global eco-friendly policies is emphasized, the electric vehicle market is growing swiftly, and research and development on secondary batteries are being actively conducted worldwide.

Secondary batteries may be classified into battery cells, battery modules, and battery packs according to assembly unit. In the case of battery packs, there is a trend to remove a module housing contained therein to reduce production cost and increase energy density. This structure may be defined as a cell-to-pack structure.

A module housing inside a battery pack may protect battery cells from pressure and heat outside a battery. Generally, in a cell-to-pack structure without a module housing, cylindrical and prismatic battery cells with high mechanical stiffness may be used. Pouch-type battery cells have relatively low mechanical stiffness, and so when applied to an existing cell-to-pack structure, various problems may occur, including performance degradation, electrolyte leakage, and electrical connection damage. Therefore, there is an increasing need for technologies to support and protect battery cells inside a battery pack.

The problem that the present disclosure aims to solve is to provide a battery pack capable of supplying a large amount of energy while stably protecting battery cells.

In addition, it is to provide a battery pack capable of reducing production costs and improving process speed.

In addition, it is to provide a battery pack with improved structural stability and energy density by reducing assembly errors during an assembly process of battery cells stacked inside a battery pack.

In addition, the present disclosure may be widely applied to electric vehicles, battery charging stations, and fields of green technologies such as solar power generation and wind power generation using batteries.

In addition, the present disclosure may be used in eco-friendly electric vehicles, hybrid vehicles, and the like to prevent climate change by suppressing air pollution and greenhouse gas emissions.

### SUMMARY OF THE INVENTION

A battery pack according to the present disclosure comprises: one or more battery cells comprising a main body portion for accommodating an electrode assembly therein and a mounting portion provided outside of the main body portion; a pack tray comprising a lower panel formed in parallel with a stacking direction in which the one or more battery cells are stacked and both side panels extending upward from opposite edge positions of the lower panel, and accommodating the one or more battery cells; and a support bar of which both ends are connected to the both side panels and which is formed in parallel with the stacking direction, wherein the mounting portion is mounted on the support bar.

The battery cells may be movable along the stacking direction.

The battery pack may further comprise a through hole penetrating the mounting portion along the stacking direction, and the support bar may be inserted into the through hole.

The mounting portion may comprise a ring-shaped hook a part of which is opened, and the hook may be mounted on the support bar.

The main body portion may be disposed between the support bar and the lower panel.

The length of the support bar may be longer than a stacked length of the one or more battery cells.

The battery pack may further comprise a partition member positioned between the one or more battery cells on the lower panel to partition a space in which the battery cells are accommodated.

The partition member may be connectable to the lower panel.

The partition member may comprise a partition panel for partitioning the battery cells and an insertion portion into which the support bar is inserted.

The insertion portion may be provided in the form of a groove formed by having at least a part of one side of the partition panel be recessed.

The insertion portion may be provided in the form of a hole which is formed by having at least a part of one side of the partition panel protrude and having the same be penetrated along a stacking direction of the battery cells.

The support bar may comprise a guide groove formed by having one side be recessed to prevent movement of the battery cells.

The guide grooves have a spacing that may be longer than or equal to a length of the battery cells along the stacking direction.

The support bar has one side that may be provided in a wavy shape.

In the wavey shape, a gap between one trough and another trough adjacent to the one trough may be greater than or equal to a length of the battery cells along the stacking direction.

The battery cell according to the present disclosure comprises an electrode assembly comprising a cathode, an anode, and a separator, a battery case accommodating the electrode assembly, a main body portion comprising electrodes terminal one end of which is connected to the electrode assembly and the other end protrudes to an outside of the battery case; and a mounting portion provided on an outside of the battery case to mount the battery case.

The mounting portion may comprise a through hole formed by being penetrated.

The mounting portion may comprise a ring-shaped hook a part of which is opened.

The mounting portion may comprise a same material as the main body portion, and at least one surface of the mounting portion may be coplanar with at least one surface of the main body portion.

The mounting portion and the main body portion may be formed integrally, and a thickness of the mounting portion and a thickness of the main body portion may be equal.

According to the present disclosure, a battery pack capable of supplying a large amount of energy while stably maintaining battery cells can be provided

In addition, a battery pack capable of reducing production costs and improve process speed can be provided.

In addition, a battery pack with improved structural stability and energy density by reducing assembly errors during an assembly process of battery cells stacked inside a battery pack can be provided.

### BRIEF DESCRIPTION OF THE DRAWINGS

FIG. 1 illustrates a battery cell according to the present disclosure.

FIG. 2 illustrates another example of a battery cell according to the present disclosure.

FIG. 3 illustrates a battery pack according to the present disclosure.

FIG. 4 illustrates a cross-section of a battery pack according to the present disclosure.

FIG. 5 illustrates a partition member according to the present disclosure.

FIG. 6 illustrates another example of a partition member according to the present disclosure.

FIG. 7 illustrates a support bar and a battery cell according to the present disclosure.

FIG. 8 illustrates another example of a support bar according to the present disclosure.

### DETAILED DESCRIPTION

Hereinafter, preferred embodiments of the present disclosure will be described in detail with reference to the attached drawings. The configuration or control method of the device described below is only for explaining the embodiments of the present disclosure and is not intended to limit the scope of the present disclosure, and the same reference numerals used throughout the specification indicate the same components.

Specific terms used in this specification are merely for convenience of explanation and are not used to limit the embodiments presented as examples.

For example, expressions such as “same” and “is the same” not only indicate a strictly identical state, but also indicate a state in which there is a tolerance or a difference in a degree to which the same function may be achieved.

For example, expressions that express relative or absolute arrangement, such as “in a certain direction,” “along a certain direction,” “side by side,” “perpendicularly,” “to the center,” “concentric,” or “coaxial,” not only strictly represent the arrangement but also represent a state of relative displacement with a tolerance or an angle or distance in a degree to which the same function may be achieved.

To explain the present disclosure, description provided below is based on a spatial orthogonal coordinate system with X, Y, and Z axes orthogonal to each other. Each axis direction (X-axis direction, Y-axis direction, Z-axis direction) refers to both directions in which each axis extends.

The X-direction, Y-direction, and Z-direction mentioned below are for explanation so that the present disclosure may be clearly understood, and of course, the directions may be defined differently depending on where the reference is placed.

The use of terms such as ‘first, second, and third’ in front of components mentioned below is only to avoid confusion about the components referred to, and is not related to the order, importance, master-slave relationship or the like between the components. For example, an invention that comprises only a second component without a first component may also be implemented.

As used in this specification, singular expressions comprise plural expressions unless the context clearly dictates otherwise.

The battery pack 200 according to the present disclosure comprises one or more battery cells 1 comprising a main body portion 10 and a mounting portion 20; a pack tray 201 for accommodating one or more battery cells 1; and a support bar 220, wherein the mounting portion 20 is mounted on the support bar 220.

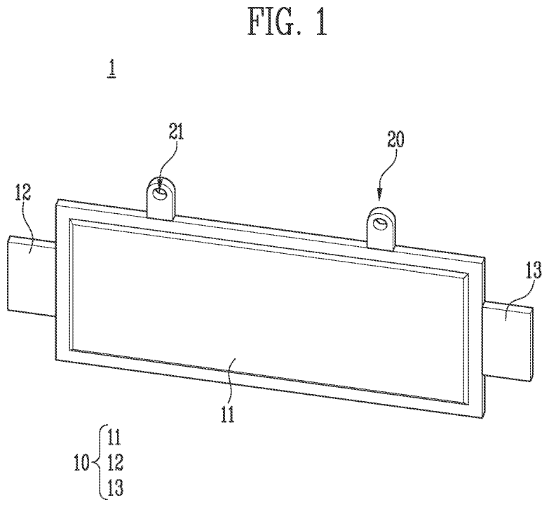

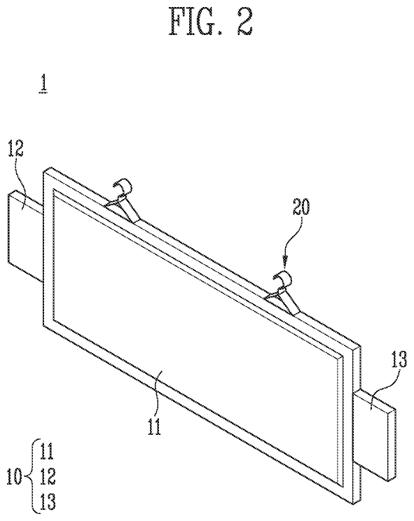

FIG. 1 illustrates a battery cell 1 according to the present disclosure, and FIG. 2 illustrates another example of a battery cell 1 according to the present disclosure.

Referring to FIG. 1, the battery cell 1 comprises a main body portion 10 and a mounting portion 20. Battery cells 1 may be classified into pouch-type secondary batteries, prismatic secondary batteries, or cylindrical secondary batteries according to their shape. In this specification, a pouch-type secondary battery is illustrated as an example for convenience of explanation, but it is not limited thereto.

The main body portion 10 may accommodate an electrode assembly therein. The electrode assembly may comprise a cathode, an anode, and a separator. A cathode may comprise a cathode active material, and an anode may contain an anode active material which lithium (Li) ions generated from a cathode active material may be inserted to and extracted from. In addition, a cathode and an anode may each further comprise a binder and a conductive material to improve mechanical stability and electrical conductivity. A separator may be configured to prevent electrical short circuit between a cathode and an anode and to generate a flow of ions. The type of a separator is not particularly limited, but may comprise a porous polymer film. An electrode assembly may be manufactured by stacking, zigzag stacking, or winding by alternately stacking a plurality of cathodes and anodes and interposing a separator between a cathode and an anode.

The main body portion 10 comprises a battery case 11 for accommodating an electrode assembly. A battery case 11 may accommodate an electrode assembly therein. For an exterior material of a battery case 11, aluminum may be used as a material for a metal layer, but is not limited thereto. A battery case 11 may have a hexahedral shape.

The main body portion 10 comprises electrode terminals 12 and 13 one end of which is connected to an electrode assembly and the other end of which protrudes to an outside of a battery case 11. Energy may be supplied to an outside through an electrode terminal. Electrode terminals 12 and 13 may comprise a cathode terminal 12 and an anode terminal 13. A cathode terminal 12 and an anode terminal 13 may protrude in a same direction. In addition, a cathode terminal 12 and an anode terminal 13 may protrude in opposite directions from two opposing sides of a battery case 11.

A battery cell 1 comprises a mounting portion 20 provided on an outside of a main body portion 10. A mounting portion 20 may be provided to mount a battery case 11. A mounting portion 20 may be provided to protrude from an edge of a main body portion 10. A mounting portion 20 may be positioned on a side (e.g. a second side) that is different from one side (e.g. first side) of a main body portion 10 where an electrode terminal is located. For example, the first side and the second side may be perpendicular to each other. Through this, damage to an electrode terminal may be prevented and efficiency of stacking may be improved.

A mounting portion 20 may be manufactured integrally with a main body portion 10. For example, at least one surface of a mounting portion 20 may be coplanar with at least one surface of a main body portion 10. To this end, a main body portion 10 may be spread out on a flat surface. An electrode assembly may be placed on a main body portion 10, and a main body portion 10 may be folded in half. After folding a main body portion 10, an edge of a main body portion 10 may be partially sealed through heat fusion or pressure fusion. The fusion method is not limited thereto as long as sealing may be achieved. A gas generated inside a main body portion 10 may be discharged through an unsealed region of a main body portion 10. After a gas is discharged, a main body portion 10 may be cut along a region previously marked on a main body portion 10 to seal a main body portion 10. A shape of a mounting portion 20 may change depending on a shape of a previously marked region. Without being limited thereto, a mounting portion 20 may be manufactured separately from a main body portion 10. A mounting portion 20 may be manufactured separately and then combined with a main body portion 10.

The mounting portion and the main body portion may be formed integrally, and a thickness of the mounting portion and a thickness of the main body portion may be formed to be equal. Referring to FIG. 1, when a battery cell is viewed from a direction in which an electrode tab protrudes, a thickness of the mounting portion and a thickness of the main body portion may be equal.

Referring to FIGS. 1 and 2 , a mounting portion 20 may comprise a through hole 21 formed by penetrating therethrough. In another embodiment, a mounting portion 20 may comprise a ring-shaped hook a part of which is opened.

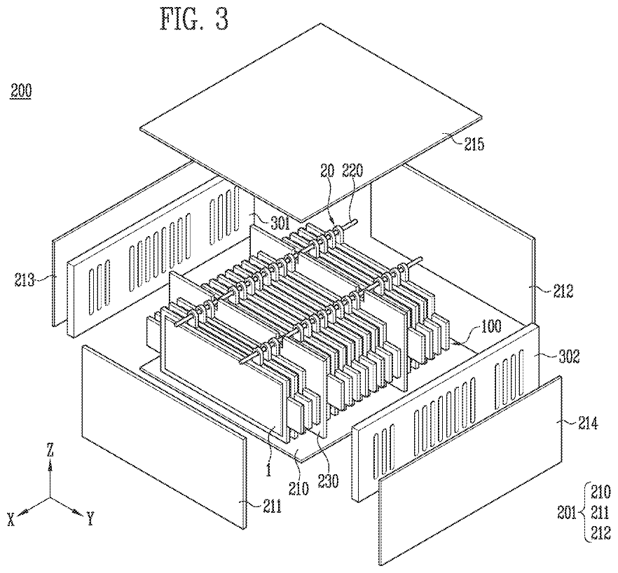

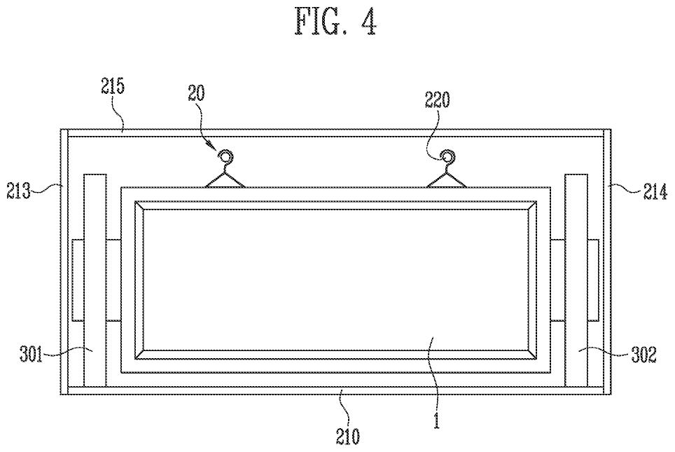

FIG. 3 illustrates a battery pack 200 according to the present disclosure, and FIG. 4 illustrates a cross-section of a battery pack 200 according to the present disclosure.

Referring to FIG. 3, a battery pack 200 according to the present disclosure comprises a lower panel 210 formed in parallel with a stacking direction in which battery cells 1 are stacked and side panels 211, 212 extending upward from opposite edge positions of a lower panel 210, and comprises a pack tray 201 for accommodating one or more battery cells 1.

To configure a battery pack 200, one or more battery cells 1 may be stacked inside a pack tray 201. A module housing may be provided inside a typical pack tray 201 to maintain arrangement of battery cells 1 and protect battery cells 1 from an external shock. For a battery pack 200 according to the present disclosure, arrangement of battery cells 1 may be maintained without providing a module housing. In addition, structural stability of a battery pack 200 may be improved.

Battery cells 1 may be stacked along a certain direction. A stacking direction in which battery cells 1 are stacked may be in parallel with a ground. Battery cells 1 may be stacked along a certain direction to form one cell assembly 100. Referring to FIG. 3, battery cells 1 may be stacked along the X direction. Through this, a cell assembly 100 in which one or more battery cells are stacked may be formed. Another cell assembly 100 may be formed in parallel with one cell assembly 100. Therefore, a battery pack 200 may comprise one or more cell assemblies 100.

A pack tray 201 comprises a lower panel 210 that is in parallel with a direction in which battery cells 1 are stacked. A lower panel 210 may support one side of one or more battery cells 1. A lower panel 210 may further comprise a partition groove. As will be described later, a partition groove may be connected to a partition member 230.

A pack tray 201 comprises side panels 211, 212, 213, 214 extending upward from opposing edge positions of a lower panel 210. Side panels 211, 212 may comprise a first side panel 211 and a second side panel 212 that cover both ends of a cell assembly. Side panels 211, 212 may be connected to a lower panel 210 to form an accommodating space. Side panels may be formed integrally with a lower panel 210. Alternatively, side panels and a lower panel 210 may be provided as separate plates and connected. A pack tray 201 may have a hexahedral shape in which a lower panel 210 and side panels are connected and an upper part is open. A pack tray 201 may further comprise an upper panel 215. A lower panel, side panels, and an upper panel may be connected to form a sealed hexahedron. Being sealed does not mean that an outside and an inside of a pack tray are completely blocked; it rather means that a component of a battery pack does not escape from an inside.

A battery pack 200 according to the present disclosure comprises a support bar 220. Both ends of a support bar 220 are connected to side panels 211, 212, and may be formed to be in parallel with a stacking direction of battery cells 1. A support bar 220 may be provided in a bar shape to be disposed in an accommodating space. One end of a support bar 220 may be connected to a first side panel 211 and the other end may be connected to a second side panel 212 to be positioned inside an accommodating space. A support bar 220 may be made of a material with high mechanical stiffness. Through this, damage to a support bar 220 may be prevented even when side panels 211, 212 are pressed by external pressure. A plurality of support bars 220 may be provided.

A support bar 220 may be provided to be longer than a length in which one or more battery cells 1 are stacked. Therefore, one or more battery cells 1 may all be mounted on a support bar 220. Through this, arrangement of cell assembly 100 may be maintained stably.

A mounting portion 20 of a battery cell 1 may be mounted on a support bar 220. Through this, arrangement of battery cells 1 may be maintained inside a pack tray 201.

A battery cell 1 may be move along a stacking direction. Since a support bar 220 is formed to be in parallel with a stacking direction, a battery cell 1 may be movable along a stacking direction after being mounted on a support bar 220. A support bar 220 may be disposed in a pack tray 201 considering a length of a battery cell 1. Referring to FIG. 3, a measurement structure of a battery cell 1 may be preset by measuring a length of a battery cell 1 in advance in the X and Y directions. By disposing a support bar 220 at a preset position, a battery cell 1 may be efficiently accommodated inside a pack tray 201.

A battery pack 200 according to the present disclosure comprises a through hole 21 through which a mounting portion 20 is penetrated along a stacking direction, and a support bar 220 may be inserted into a through hole 21. Through a through hole 21, a battery cell 1 may be stably inserted and mounted on a support bar 220. Referring to FIG. 3, stacking may be performed such that a wide side of a battery cell 1 may face a wide side of an adjacent battery cell. A through hole 21 may also be formed to penetrate in a direction from a wide side of a battery cell 1 to a wide side of an opposite side. A diameter of a through hole 21 may be formed to be greater than or equal to a diameter of a support bar 220. Through this, a battery cell 1 may be movable after being mounted on a support bar 220.

In addition, a mounting portion 20 may comprise a ring-shaped hook a part of which is opened, and a hook may be mounted on a support bar 220. Ease of movement may be improved after a battery cell 1 is mounted on a support bar 220 through a partially open ring-shaped hook. A shape of a mounting portion 20 is not limited thereto, and may comprise any shape that may be inserted into or mounted on a support bar 220.

A main body portion 10 of a battery pack 200 according to the present disclosure may be disposed between a support bar 220 and a lower panel 210. When one or more battery cells 1 are disposed on a lower panel 210, a support bar 220 may be positioned on a battery cell 1. Therefore, a support bar 220 and a lower side panel 210 may form an accommodating space of a main body portion 10. Through this, a main body portion 10 may be protected from external pressure. Referring to FIG. 4, a ring-shaped hook may be inserted into a mounting portion 20. A main body portion 10 may be positioned between a support bar 220 and a lower panel 210 so that a main body portion 10 may be protected stably.

A battery pack 200 according to the present disclosure may further comprise a bus bar for electrically connecting one or more battery cells 1. A bus bar may connect a main body portion 10 of one battery cell 1 with a main body portion 10 of an adjacent battery cell 1. A bus bar may comprise a first bus bar 301 and a second bus bar 302.

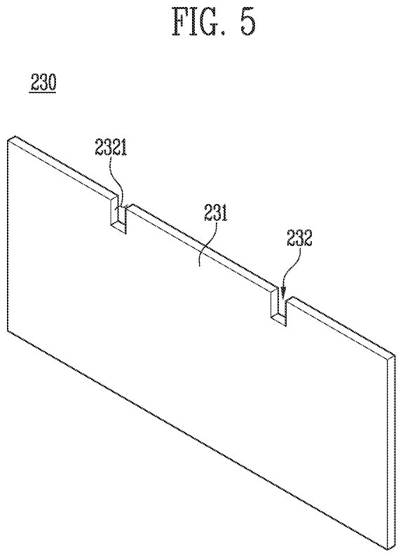

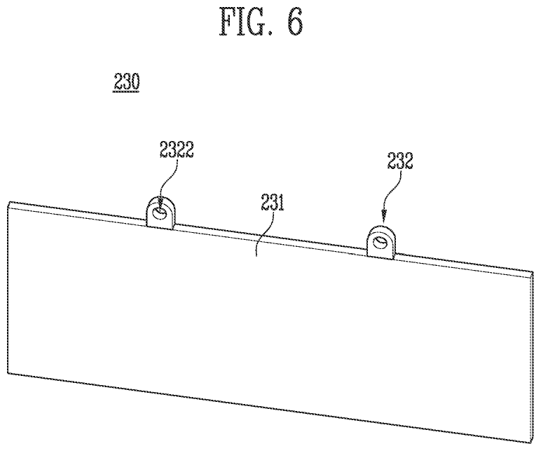

FIG. 5 illustrates a partition member 230 according to the present disclosure, and FIG. 6 illustrates another example of a partition member 230 according to the present disclosure.

A battery pack 200 according to the present disclosure may further comprise a partition member 230. A partition member may be positioned on a lower panel between one or more battery cells 1. A plurality of battery cells 1 may be stacked, and a partition member 230 may be located. Thereafter, battery cells 1 may be stacked along a stacking direction. In an embodiment, battery cells 1 and partition members 230 may be alternately stacked. In addition, a partition member 230 may be positioned between an outermost battery cell 1 and a first side panel 211 and between an outermost battery cell 1 and a second side panel 212.

A partition member 230 may be coupled with a lower panel 210. For example, a lower panel 210 may comprise a coupling groove for being coupled with a partition member 230. When a partition member is inserted into a coupling groove and thus a partition member receives pressure from a side, a position thereof may be fixed. As another example, coupling may be achieved through an adhesive mean. Alternatively, coupling may be achieved through a male-female connecting structure. Not being limited thereto, other means for connecting a partition member and a lower panel may be included. Coupling grooves may be arranged according to a preset interval.

A dual protective structure may be formed through a partition member 230. Primary protection may be achieved through a side panel, and secondary protection may be provided through a partition member 230.

A partition member 230 may comprise a partition panel 231 for partitioning battery cells 1 and an insertion portion 232 into which a support bar 220 is inserted. A partition panel 231 may have a flat shape. A partition panel 231 needs to accommodate battery cells 1 by distributing pressure therefrom. Therefore, a flat shape may be provided to contact battery cells 1 over a large area. A partition panel 231 may be inserted into a support bar 220 to can move along a stacking direction. Through this, a space inside a pack tray 201 may be used efficiently.

An insertion portion 232 may be provided in the form of a groove formed by having at least a part of one side of a partition panel 231 be recessed. Referring to FIG. 5, a partition panel recessed portion 2321 formed by having a part of a partition panel 231 be recessed may be provided. A support bar 220 may be inserted into a partition panel depression 2321.

In addition, an insertion portion may be provided in the form of a hole which is formed by having at least a part of one side of a partition panel 231 protrude and having the same be penetrated along a stacking direction. Referring to FIG. 6, a part of a partition panel 231 may protrude, and a partition panel through hole 2322 may be provided as a protruding region is penetrated. A support bar 220 may be inserted through a partition panel through hole 2322.

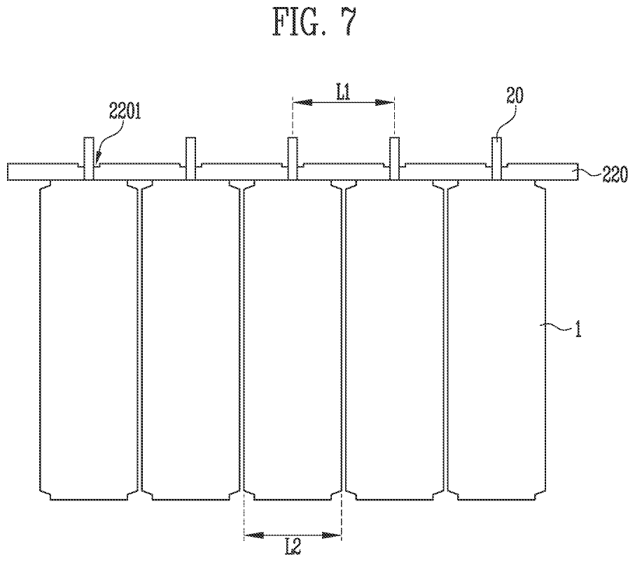

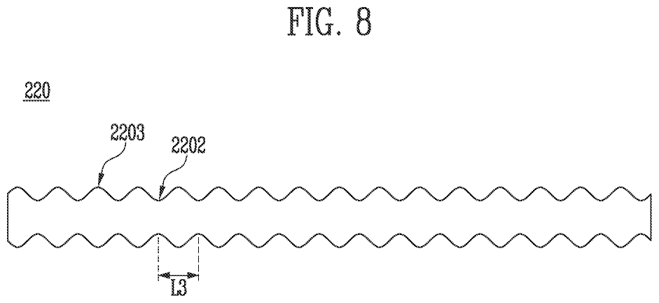

FIG. 7 illustrates a support bar 220 and a battery cell 1 according to the present disclosure, and FIG. 8 illustrates another example of a support bar 220 according to the present disclosure.

A support bar 220 according to the present disclosure may comprise a guide groove 2201 formed by having one side be recessed to prevent movement of a battery cell 1. A battery cell 1 is mounted on a support bar 220 to move along a stacking direction. When battery cells 1 are stacked and then continue to move, vibration may occur, which may deteriorate structural stability of a battery pack 200. Therefore, to prevent a battery cell 1 from moving after a battery cell 1 has moved to a preset position, a mounting portion 20 of a battery cell 1 may be inserted to a guide groove 2201 of a support bar 220. When a mounting portion 20 is inserted, a battery cell 1 may be prevented from moving despite external pressure.

Specifically, FIG. 7 illustrates a cross-section of a plurality of battery cells 1 mounted on a support bar 220. As an example, five battery cells 1 that are mounted are illustrated but the present invention is not limited thereto. A support bar 220 may extend in parallel along a stacking direction in which battery cells 1 are stacked, and a plurality of battery cells 1 may be sequentially mounted on a support bar 220. A mounting portion 20 of a battery cell 1 may be seated at a guide groove 2201 of a support bar 220. A spacing L1 of guide grooves 2201 may be greater than or equal to a length L2 of a battery cell 1 based on a stacking direction. When a gap L1 between guide grooves 2201 is narrowly disposed, battery cells 1 may be too close to each other, and thus adjacent battery cells 1 may receive pressure from each other. In addition, when a spacing L1 of guide grooves 2201 is disposed wide, energy density of a battery pack 200 may decrease. Therefore, a spacing L1 of guide grooves 2201 may preferably be provided to be longer than a length L2 of a battery cell 1 so that battery cells 1 may be efficiently disposed.

One side of a support bar may be provided in a wavy shape. A wavey shape may comprise a crest 2203 and a trough 2202. A gap L3 between a trough 2202 and an adjacent trough 2202 may be provided to be constant. A gap between a trough 2202 and an adjacent trough 2202 may 2202 may be provided to be longer than a length of a battery cell 1 along a stacking direction. Through this, energy density of a battery pack 200 may be increased and structural stability may be improved.

The present disclosure may be modified and implemented in various forms, and its scope is not limited to the embodiments described above. Therefore, when a modified embodiment comprises elements of the claims of the present disclosure, it should be regarded as falling within the scope of the present disclosure.

What is claimed is:

1. A battery pack comprising: one or more battery cells comprising a main body portion for accommodating an electrode assembly therein and a mounting portion provided outside of the main body portion;
a pack tray comprising a lower panel formed in parallel with a stacking direction in which the one or more battery cells are stacked and both side panels extending upward from opposite edge positions of the lower panel, and accommodating the one or more battery cells; and
a support bar of which both ends are connected to the both side panels and which is formed in parallel with the stacking direction,
wherein the mounting portion is mounted on the support bar.

2. The battery pack according to claim 1, wherein the battery cells are movable along the stacking direction.

3. The battery pack according to claim 1, further comprising a through hole penetrating the mounting portion along the stacking direction, wherein the support bar is inserted into the through hole.

4. The battery pack according to claim 1, wherein the mounting portion comprises a ring-shaped hook a part of which is opened, and the hook is mounted on the support bar.

5. The battery pack according to claim 1, wherein the main body portion is disposed between the support bar and the lower panel.

6. The battery pack according to claim 1, wherein a length of the support bar is longer than a stacked length of the one or more battery cells.

7. The battery pack according to claim 1, further comprising a partition member positioned between the one or more battery cells on the lower panel to partition a space in which the battery cells are accommodated.

8. The battery pack according to claim 7, wherein the partition member is connectable to the lower panel.

9. The battery pack according to claim 7, wherein the partition member comprises a partition panel for partitioning the battery cells and an insertion portion into which the support bar is inserted.

10. The battery pack according to claim 9, wherein the insertion portion is provided in the form of a groove formed by having at least a part of one side of the partition panel be recessed.

11. The battery pack according to claim 9, wherein the insertion portion is provided in the form of a hole which is formed by having at least a part of one side of the partition panel protrude and having the same be penetrated along a stacking direction of the battery cells.

12. The battery pack according to claim 1, wherein the support bar comprises a guide groove formed by having one side be recessed to prevent movement of the battery cells.

13. The battery pack according to claim 12, wherein the guide grooves have a spacing that is longer than or equal to a length of the battery cells along the stacking direction.

14. The battery pack according to claim 1, wherein the support bar has one side that is provided in a wavy shape.

15. The battery pack according to claim 14, wherein the wavy shape, a gap between one trough and another trough adjacent to the one trough is greater than or equal to a length of the battery cells along the stacking direction.

16. A battery cell comprising: an electrode assembly comprising a cathode, an anode, and a separator, a battery case accommodating the electrode assembly, a main body portion comprising electrodes terminal one end of which is connected to the electrode assembly and the other end protrudes to an outside of the battery case; and
a mounting portion provided on an outside of the battery case to mount the battery case.

17. The battery cell according to claim 16, wherein the mounting portion comprises a through hole formed by being penetrated.

18. The battery cell according to claim 16, wherein the mounting portion comprises a ring-shaped hook a part of which is opened.

19. The battery cell according to claim 16, wherein the mounting portion comprises a same material as the main body portion, and at least one surface of the mounting portion is coplanar with at least one surface of the main body portion.

20. The battery cell according to claim 16, wherein the mounting portion and the main body portion are formed integrally, and a thickness of the mounting portion and a thickness of the main body portion are equal.
